(19) United States
(12) Patent Application Publication
(10) Pub. No.: US 2007/0022570 A1
(43) Pub. Date: Feb. 1, 2007

(54) FULLY ENCLOSED DETENT HINGE MECHANISM

(76) Inventors: James Edward SELF, Colby (GB); Graham Robin Lock, Glen Vine (GB); Robert William Stimpson, Douglas (GB)

Correspondence Address: FLEIT KAIN GIBBONS GUTMAN BONGINI & BIANCO, 21355 EAST DIXIE HIGHWAY, SUITE 115, MIAMI, FL, 33180, US

(21) Appl. No.: 11/456,352

(22) Filed: Jul. 10, 2006

(30) Foreign Application Priority Data
Jul. 26, 2005 (GB) 0515286.3

(51) Int. Cl. E05D 11/10

(52) U.S. Cl. 16/334

(57) ABSTRACT

A fully enclosed detent hinge mechanism for a foldable bathroom shower seat or other hinged device, comprising a hinge housing; a rotatable element rotatable received in the hinge housing and connectable or connected to a hingably movable part of the hinged device for angular displacement therewith; and a detent mechanism which releasably retains the hingably movable part of the hinged device when in a raised, condition. The detent mechanism includes a first detent part located on the hinge housing and a second detent part located on the rotatable element and which is cooperable with the first detent part to prevent or substantially prevent unintentional movement of the rotatable element in the hinge housing. One of the first and second detent parts includes an integrally formed cantilever arm which is cooperable with a remaining said one of the first and second detent parts to prevent or substantially prevent unintentional movement of the rotatable element in the hinge housing.

### BACKGROUND OF THE INVENTION

This invention relates to a fully enclosed detent hinge mechanism, particularly, but not exclusively, for a foldable bathroom shower seat,

Shower seats are commonly used in bathrooms to allow, in particular, elderly and infirm users to be seated while showering. Shower seats can be freestanding or attached to a wall of the bathroom. In the latter ease, it is convenient to make the shower seat foldable so that it can be lifted out of the way to prevent obstruction when, for example, cleaning the shower area

In the case of a foldable shower seat, typically the hinges are exposed and a discrete latch or catch mechanism is provided fixed to the bathroom wall to engage and retain the shower seat once lifted. The exposed hinges can trap flesh or hair of a user, and the discrete latch or catch can lead to cuts and bruises through accidental contact.

The present invention seeks to provide a solution to these problems.

### SUMMARY OF THE INVENTION

According In a first aspect of the present invention, there is provided a fully enclosed detent hinge mechanism for a hinged device, the fully enclosed detent hinge mechanism comprising a hinge housing; a rotatable element rotatably received in the said hinge housing and connectable or connected to a hingably movable part of the said hinged device for angular displacement therewith; and a detent mechanism which releasably retains the hingably movable part of the hinged device, when the hingably movable part is moved to one position, the said detent mechanism including a first detent part located on the hinge housing and a second detent part located on the rotatable element and which is cooperable with the said first detent part to prevent or substantially prevent unintentional movement of the rotatable element in the hinge housing, wherein one of the first and second detent parts includes an integrally formed cantilever arm which is cooperable with a remaining said one of the first and second detent parts to prevent or substantially prevent unintentional movement of the rotatable element in the hinge housing

According to a second aspect of the invention, there is provided a hinged device having a hinge mechanism in accordance with the first aspect of the invention.

According to a third aspect of the invention, there is provided a fully enclosed detent hinge mechanism for a foldable bathroom shower seat or other hinged device, the fully enclosed detent hinge mechanism comprising a hinge housing; a rotatable element rotatably received in the hinge housing and connectable or connected to a hingably movable part of the hinged device for angular displacement therewith; and detent means for releasably retaining the hingably movable part of the hinged device in a particular condition, the detent means including, a first detent part located on the hinge housing and a second detent part located on the rotatable element and which is cooperable with the first detent part to prevent or substantially prevent unintentional movement of the rotatable element in the hinge housing, one of the first and second detent parts being in the form of one or more cantilever arms.

The invention will now be more particularly described, by way of example only, with reference to the accompanying drawings.

### BRIEF DESCRIPTION OF THE DRAWINGS

FIG. 1 is a perspective of a foldable bathroom shower seat in a lowered condition and having a hinge mechanism in accordance with the first aspect of the invention;

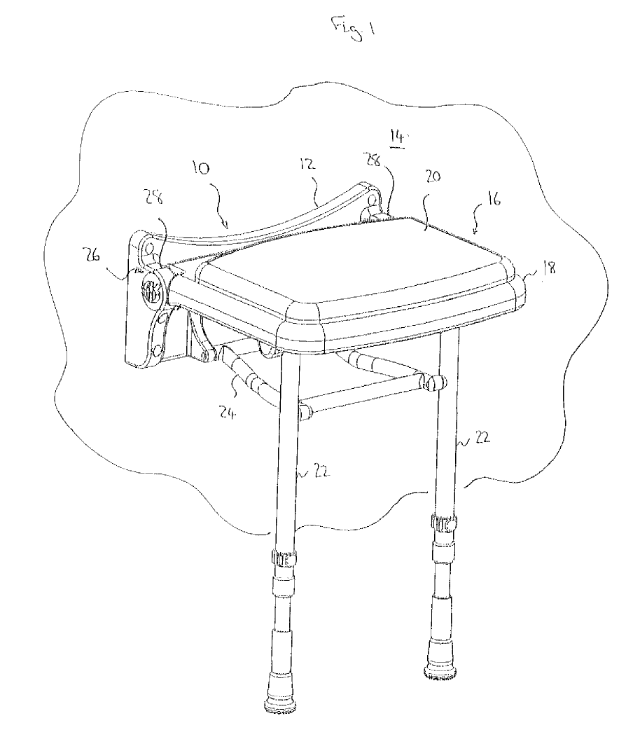

FIG. 2 is an exploded scrap view of one side of the shower seat, shown in FIG. 1 and with the cushion removed;

FIG. 3 is an enlarged exploded view of the hinge mechanism with a seat element removed for clarity;

FIG. 4 is a cross-sectional view through the hinge mechanism and seat element, taken from the front of the shower seat shown in FIG. 1;

FIGS. 5a and 5b are perspective views from different sides of a rotatable element having a second detent part; and

FIGS. 6a and 6b are perspective views from different sides of a coupling element which connects the seat element to the hinge mechanism.

### DESCRIPTION OF THE PREFERRED EMBODIMENTS

Referring now to the drawings, there is shown a foldable bathroom shower seat 10 which comprises a back support member 12 for fastening to a wall surface 14 of a bathroom, and a seat structure 16 hingably connected to the back support member 12. The seat structure 16 includes a seat element 18 which is hinged to the back support member 12 and which has a removable cushion 20, two spaced telescopic supporting legs 22 pivotably connected to an underside of the seat element 18, and a parallel frame element 24 pivotably connected to the telescopic supporting legs 22 and hingably connected to the back support member 12 at a position spaced from the seat element 18.

The seat element 18, frame element 24, back support member 12 and supporting legs 22 form a parallel linkage mechanism by which the supporting legs 22 are maintained vertically or substantially vertically as the seat element 18 is raised and lowered.

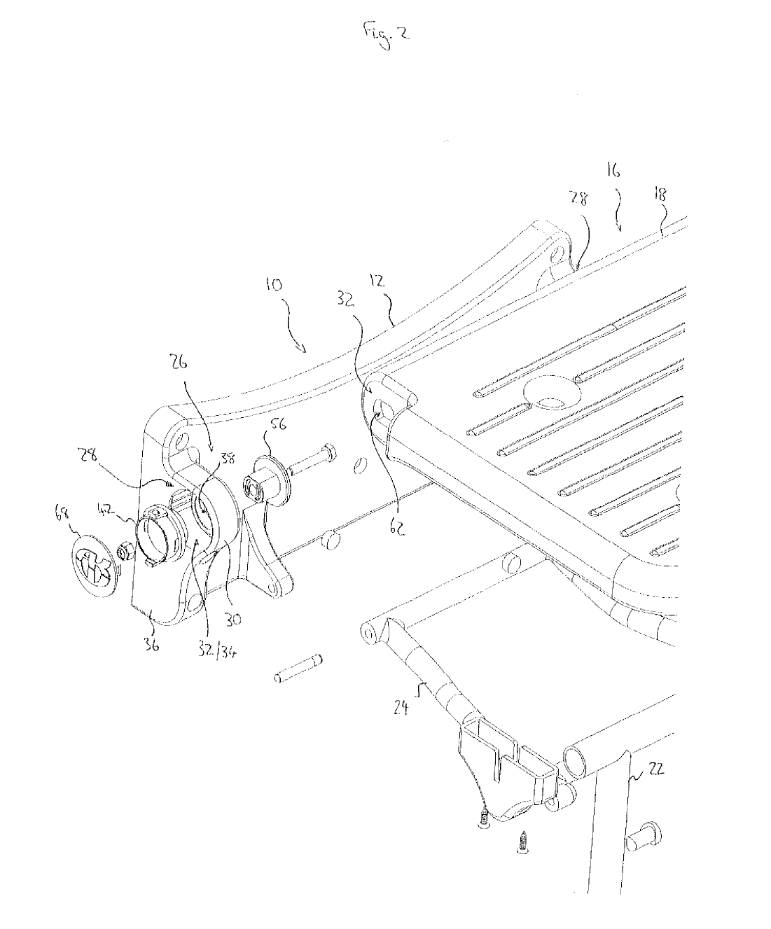

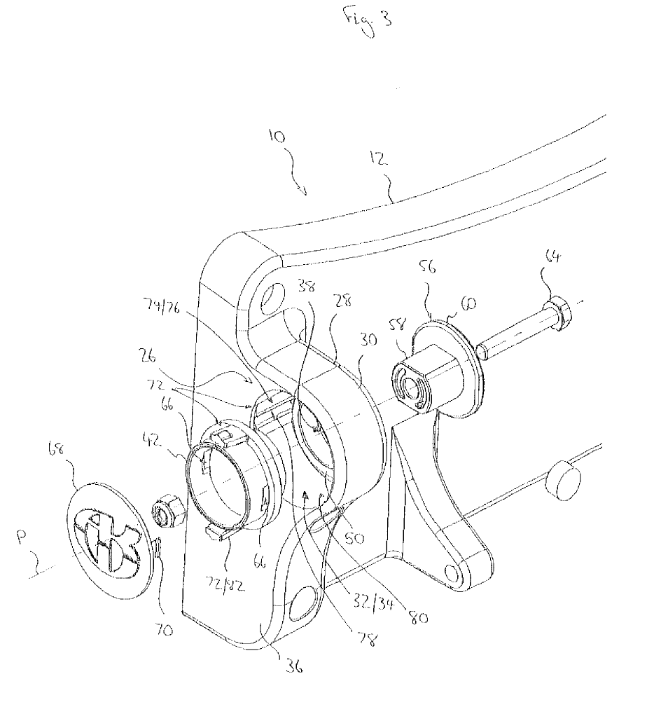

To allow the seat element 18 to hinge, an enclosed hinge mechanism 26 is provided. The back support member 12 is unitarily formed, typically by moulding, with a hinge housing 28 at each end. One of the hinge housings 28 is clearly shown in FIGS. 2 and 3. Each hinge housing 28 includes a smooth, partly arcuate exterior surface 30 which locates in a hinge recess 32 of the seat element 18 and which allows the seat element 18 to travel closely about the hinge housing 28. The interior 32 of the hinge housing 28 is generally cylindrical in the direction of a pivot axis P of the seat element 18. Access to the interior 32 of the hinge housing 28 is via a first opening 34 formed on an outwardly facing surface 36 of the back support member 12. A second opening 38 to the interior 32 of the hinge housing 28, which has a smaller diameter than that of the first opening 34, is coaxially formed on an inwardly facing surface 40 of the back support member 12.

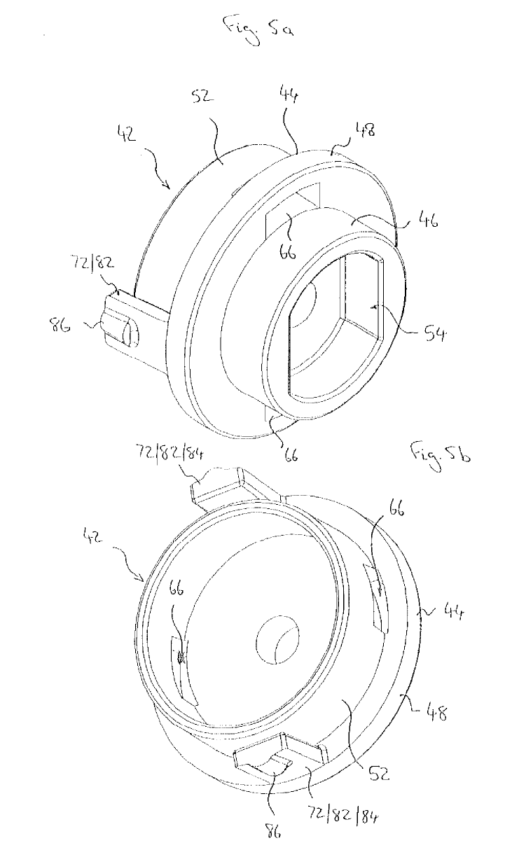

The interior 32 of the hinge housing 28 is dimensioned to fully accept a hollow rotatable element 42 having a stepped outer surface 44. As can best be seen in FIGS. 3, 4, 5a and 5b, the rotatable element 42 has a first position 46 which is receivable in the second opening 38 of the hinge housing 28, a flange portion 48 which abuts an interior surface 50 of the hinge housing 28, and a second portion 52 which has a larger diameter than the first portion 46 and which resides adjacent the first opening 34 of the hinge housing 28.

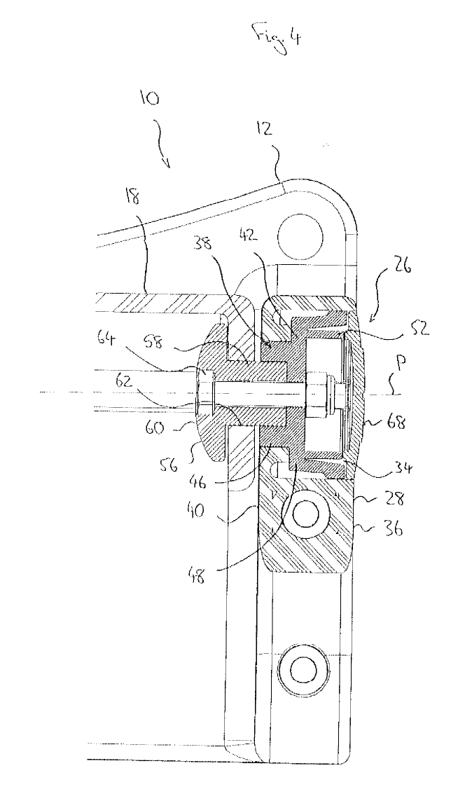

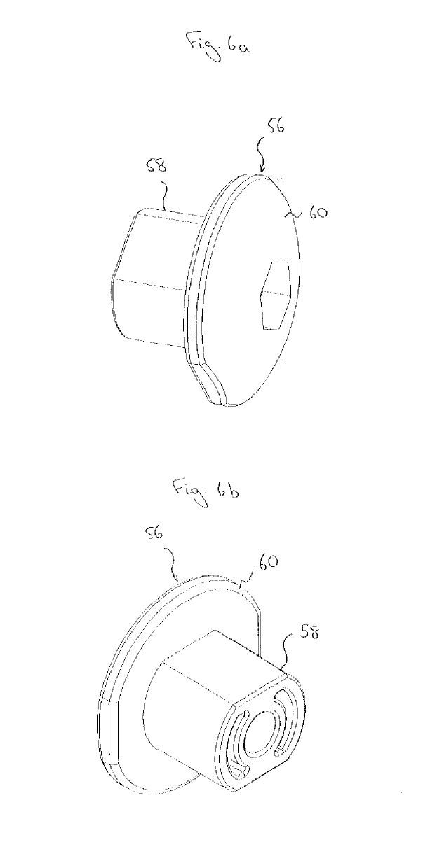

So that the rotatable element 42 rotates with the pivoting or the seat element 18, the first portion 46 of the rotatable element 42 is formed with a non-circular opening 54, which is coaxial with the pivot axis P when the rotatable element 42 is located in the housing. A coupling element 56, as shown in FIGS. 3, 4, 6a and 6b has a boss 58 integrally formed with an overlapping head 60. The boss 58 has a non-circular lateral cross-section which is shaped for complementary engagement with the non-circular opening 54 of the rotatable element 42. The seat element 18, as will be appreciated from FIGS. 2 and 4, is also provided with a non-circular opening 62 on its pivot axis P which matches or substantially matches that of the rotatable element 42. The coupling element 56 is received in the non-circular opening 62 of the seat element 18, and then in the non-circular opening 54 the rotatable element 42 A screw-threaded fastening device 64, such as a nut and bolt is then used to fasten the coupling element 56, seat element 18 and rotatable element 42 together, thus interconnecting the seat element 18 and the hinge housing 28.

The rotatable element 42 includes two diametrically opposed recesses or openings 66, and a housing cover 68 includes two hooked tabs 70 for releasable snap fit engagement therewith. The housing cover 68 is dimensioned to be a close or tolerance flush or substantially flush fit in the first opening 34 of the hinge housing 28. The housing cover 68 can display a manufacturer or product name or logo, for example. Consequently, as the rotatable element 42 rotates due to pivoting of the seat element 18, the housing cover 68, and thus also any name or logo, also rotates.

To enable the seat element 18 to be retained in a raised condition, the hinge mechanism 26 is provided with detent means 72 within one or both hinge housings 28. The detent means 72 includes a first detent part 74 in the form of two pairs of adjacent parallel inwardly projecting ridges 76 defining a trough 78 therebetween. Each pair of ridges 76 diametrically opposes the other pair of ridges 76. The ridges 76, and thus also trough 78, extend along an interior surface 80 of the hinge housing 28, between or substantially between the first and second openings 34 and 38, and are formed in a plane which extends perpendicularly or substantially perpendicularly to the surface 14 supporting the back support member 12.

The detent means 72 also includes a second detent part 82 in the form of a pair of cantilever arms 84 formed on the flange portion 48 of the rotatable element 42 and projecting towards the first opening 34 of the hinge housing 28, when the rotatable element 42 is located in the hinge housing 28. Each arm 84 has a radially outwardly projecting protuberance 86 formed at or adjacent to a distal end thereof. The arms 84 are formed in a plane which extends parallel or substantially parallel to the surface 14 supporting the back support member 12, when the seat element 18 is in a lowered in use condition. The arms 84, as with the ridges 76, are diametrically opposed.

Once assembled, as the seat element 18 is pivoted from the lowered in use condition to the raised stored condition, the coupling element 56 turns, which rotates the rotatable element 42 in the hinge housing 28. The cantilever arms 84 move with the rotatable element 42, and as the seat element 18 becomes vertical or substantially vertical, the protuberances 86 on the ends of the cantilever arms 84 ride over the first encountered ridges 76, by flexing of the cantilever arms 84, and enter the troughs 78. The resilience of the cantilever arms 84, once the protuberances 86 are located between the ridges 76, is such as to prevent or inhibit unintentional lowering of the seat element 18 when raised, due to accidental knocking, for example.

The back support element can be replaced by any suitable support element, such as a frame support or a freestanding shower seat or chair. The support element can be one piece, as with the integral back support element described above, or more than one piece. For example, the hinge housings themselves can be independent of each other and can act as support elements which can be directly connected to a supporting surface.

The first detent part, being the ridges, can be formed on the rotatable element, and the second detent part, being the cantilever arms, can be formed on the interior surface of the hinge housing.

The first detent part may simply comprise a trough or channel formed in the interior surface of the housing, instead of utilising ridges.

The first and second detent parts may only comprise a single cantilever arm and pail of associated ridges and/or troughs. However, more than two cantilever arms and pairs of associated ridges and/or troughs can, of course, be provided.

In addition or alternatively to the first detent part being one or more ridges, any suitable projection or projections can be utilised. One or each cantilever arm can include an opening or recess, instead of or in addition to the protuberance, which is engagable with the projection.

Although the rotatable element is a discrete element which is connectable to the coupling element, the rotatable element could be integral with the coupling element and/or the seat element

The hinge mechanism described above is intended for use with a foldable bathroom shower seat. However, it can be applied to any hinged device, particularly but limited to a hinged bathroom or shower room device, such as a drop-down hand rail, toilet seat and/or shower screen.

It is thus possible to provide a fully concealed hinge mechanism which is compact, prevents or limits unintentional access resulting in trapping due to being fully enclosed, and which includes, preferably integral, detent means fully located within the hinge housing and by which a hingable part of the hinged device, attached to the hinge mechanism, can be retained in a folded, raised or particular condition.

The embodiments described above are given by way of examples only, and other modifications will be apparent to persons skilled in the art without departing from the scope of the invention as declined by the appended claims.

What is claimed is:

1. A fully enclosed detent hinge mechanism for a hinged device, the fully enclosed detent hinge mechanism comprising a hinge housing; a rotatable element rotatably received in the said hinge housing and connectable or connected to a hingably movable part of the said hinged device for angular displacement therewith; and a detent mechanism which releasably retains the hingably movable part of the hinged device, when the hingably movable part is moved to one position, the said detent mechanism including a first detent part located on the hinge housing and a second detent part located on the rotatable element and which is cooperable with the said first detent part to prevent or substantially prevent unintentional movement of the rotatable element in the hinge housing, wherein one of the first and second detent parts includes an integrally formed cantilever arm which is cooperable with a remaining said one of the first and second detent parts to prevent or substantially prevent unintentional movement of the rotatable element in the hinge housing.

2. A fully enclosed detent hinge mechanism as claimed in claim 1, wherein the said remaining one of the first and second detent parts includes a ridge which is cooperable with the said cantilever arm

3. A fully enclosed detent hinge mechanism as claimed in claim 1, wherein said cantilever arm has a protuberance which is engagable with the remaining one of the first and second detent parts.

4. A fully enclosed detent hinge mechanism as claimed in claim 1, wherein said cantilever arm has an opening or recess which is engagable with the remaining one of the first and second detent pars.

5. A fully enclosed detent hinge mechanism as claimed in claim 1, wherein the cantilever arm is integrally formed as part of one of the hinge housing and the rotatable element.

6. A fully enclosed detent hinge mechanism as claimed in claim 1, wherein the rotatable element is fully receivable in the hinge housing.

7. A fully enclosed detent hinge mechanism as claimed in claim 1, wherein the housing includes a removable cover which closes the hinge housing to prevent or limit unintentional access.

8. A fully enclosed detent hinge mechanism as claimed in claim 7, wherein the removable cover rotates with the rotatable element.

9. A fully enclosed detent hinge mechanism as claimed in claim 1, further comprising a coupling element for connecting the hingably movable part of the hinged device to the rotatable element, the coupling element including a non-circular boss for engagement with the hingably movable part, and the rotatable element including a complementarily shaped opening for receiving the non-circular boss.

10. A fully enclosed detent hinge mechanism as claimed in claim 1, wherein the hinge housing is included as part of a back plate for fixing to a wall of a bathroom.

11. A fully enclosed detent hinge mechanics as claimed in claim 1, wherein, when the hingably movable part is a seat element of a foldable shower seat, the hinge housing is or forms part of a frame structure for supporting the seat element.

12. A fully enclosed detent hinge mechanism as claimed in claim 1, being in the form of a kit parts.

13. A hinged device having a fully enclosed detent hinge mechanism as claimed in is claim 1.

14. A hinged device as claimed in claim 13, which is a foldable bathroom shower seat, drop-down hand rail, toilet seat, or shower screen

15. A fully enclosed detent hinge mechanism or a foldable bathroom shower seat or other hinged device, the fully enclosed detent hinge mechanism comprising a hinge housing; a rotatable element rotatably received in the hinge housing and connectable or connected to a hingably movable part of the hinged device for angular displacement therewith; and detent means for releasably retaining the hingably movable part of the hinged device in a particular condition, the detent means including a first detent part located on the hinge housing and a second detent part located on the rotatable element and which is cooperable with the first detent part to present or substantially prevent unintentional movement of the rotatable element in the hinge housing one of the first and second detent parts being in the form of one or more cantilever arms.
